(19) United States
(12) Patent Application Publication
(10) Pub. No.: US 2005/0188077 A1
(43) Pub. Date: Aug. 25, 2005

(54) Method of tracking and authenticating e-mails

(76) Inventors: Christopher A. Quintanilla, Philadelphia, PA (US); Michael Lee, Clifton, NJ (US); Scott Lee, East Brunswick, NJ (US); Charles S. Skinner, Amber, PA (US)

Correspondence Address: LAW OFFICES OF MARK A. GARZIA, P.C., 2058 CHICHESTER AVE, BOOTHWYN, PA, 19061, US

(21) Appl. No.: 10/782,166

(22) Filed: Feb. 19, 2004

(51) Int. Cl. G06F 15/173

(52) U.S. Cl. 709/224

(57) ABSTRACT

The present invention discloses a method and apparatus for tracking electronic mail (e-mail) that requires Internet Service Providers to use appliances registered with a central governmental agency. The appliance amends each e-mail message by attaching the serial number of the appliance and an identification code. The identification code includes information that can be used to reference log entries maintained on the appliance that can be matched to ISP records containing sender log-in information and sender connection records, thereby allowing each e-mail to be traced back to the originating ISP and sender. Receiving ISPs will be able to authenticate each ID code to ensure that the sending ISP has a registered appliance and to prevent the use of unauthorized appliances. This method/apparatus is intended to lay the groundwork for enforcing a National Do Not E-Mail registry.

### FIELD OF THE INVENTION

The present invention relates generally to electronic mail (e-mail) and, more specifically, to a system and method for tracking e-mail and optionally blocking e-mail that either cannot be traced or does not originate from a government-authorized Internet service provider.

### BACKGROUND OF THE PRIOR ART

The public's acceptance and use of the Internet has been extraordinary. Many businesses and households (referred to hereafter as subscribers) now have a connection to the Internet. In order to connect to the Internet, a subscriber usually retains the services of an Internet Service Provider (ISP).

Along with the usual service of accessing the World-Wide Web, every subscriber is usually provided (or obtains from a third-party) one or more e-mail addresses to facilitate communication with other subscribers. The other subscribers to whom a person communicates with do not have to subscribe to the same ISP as the originator. Accordingly, once an e-mail address is known, it is a simple matter to draft and forward a message to the desired recipient almost instantaneously regardless of the recipient's physical location.

As can be expected in a situation where an inexpensive and easy method of communicating with consumers is available, it is suceptible to exploitation by marketers, businesses, and other entities attempting to exploit the weaknesses of individuals. These marketers send out a tremendous volume of e-mail that is unwanted, unauthorized and unsolicited by the recipients. This unwanted and unauthorized e-mail is generically referred to as “spam” (not to be confused with Hormel Foods Corporation's SPAM® food products). It is estimated that approximately two-thirds of the e-mail messages each subscriber receives is spam.

The spam sent by these marketers has hit epidemic proportions and the messages have clogged the Internet. Accordingly, Internet Service Providers have implemented filters to block this tremendous volume of unwanted and unsolicited e-mail and subscribers can purchase software designed to specifically block with unwanted e-mail at their computer. This method is unreliable however since legitimate e-mail messages sometimes get blocked by these filteringm methods.

Another common method used by ISPs to block the unwanted spam is to create an exclusion list of known spammers and to block all e-mail originating from the general e-mail address. This method is also unreliable however since spammers frequently change their e-mail address and the ISPs must constantly update their list.

Additionally, spammers have become more adept at sending unsolicited e-mail messages by disguising the tracking information contained in e-mail messages, contained in, and sometimes referred to as, headers, so as to make it more difficult to discern the actual originator of an e-mail message, thereby allowing spammers to send mail from non-existent, fraudulent or impersonated e-mail addresses.

### SUMMARY OF THE INVENTION

The present invention provides a method and apparatus of tracking electronic mail (e-mail) transmitted by a sender. The method comprises the steps of requiring each Internet Service Provider (ISP) to utilize an appliance that is registered with and/or issued by a government agency. The appliance can be an actual physical device or it can be implemented in software. Each appliance will have its own serial number. Without an effective means to track the true origin of e-mail messages, independently of existing e-mail message headers that may or may not be accurate, it will not be feasible to implement a “National Do Not E-Mail Registry” that government agencies will be able to enforce.

The invention will help government agencies determine who is accountable for originating most e-mail messages, thereby helping to enforce a “National Do Not E-Mail Registry”. Additionally, the invention will help Internet Service Providers and E-Mail providers lessen the amount of untraceable e-mail traffic their customers receive. Whenever a sender forwards an e-mail message, the appliance amends the e-mail message with an encrypted code containing an identification code unique to each e-mail sent through an ISP and the serial number of said appliance. This unique identification code will allow other ISPs or government agencies to track the e-mail message back to the originating ISP and sender.

The identification code can be encrypted and changed so that no patterns will be readily apparent to hackers or other interested parties.

In addition, an identification code can be used to cross reference an ISP's customer log-in and customer connection records thereby allowing the e-mail to be traced back to the sender.

After each e-mail message has been amended, the e-mail is transmitted by the sending ISP. The receiving ISP may opt to validate all incoming e-mails to ensure that the e-mails originate from a registered appliance. If the e-mail originates from an unregistered appliance or the identification code is not valid, then the e-mail can be allowed to continue onto the recipient, labeled as “UNTRACKABLE” or rejected by the receiving ISP, at the ISP's discretion.

The above method can be adapted to track SMTP mail messages or TCP/IP packets.

While it is not designed to bring a direct halt to the delivery of SPAM e-mail, the invention will indirectly lessen SPAM e-mail by allowing the government to enforce violations of a “National Do Not E-Mail Registry”, thereby deterring SPAM e-mail via fines and other methods of prosecution.

Additionally, Internet Service Providers will be able to help safeguard its users from unwanted and untraceable e-mail messages by blocking mail from Internet Service Providers that do not utilize the invention.

### BRIEF DESCRIPTION OF THE DRAWINGS

The accompanying drawings, which are incorporated in and form a part of the specification, illustrate the embodiments of the present invention and, together with the following description, serve to explain the principles of the invention. For the purpose of illustrating the invention, embodiments are shown in the drawings which are presently preferred, it being understood, however, that the invention is not limited to the specific instrumentality or the precise arrangement of elements or process steps disclosed.

In the drawings:

FIG. 1 is a block diagram of the process of adding a code to electronic mail messages according to the present invention.

FIG. 2 is a block diagram of the handling/authentication process utilized by the invention to handle the added code as illustrated in FIG. 1.

FIG. 3 is a block diagram of the reverse authentication request process utilized by the invention to handle the added code as illustrated in FIG. 1.

FIG. 4 is an overall conceptual diagram illustrating the processes and entities that may be used to implement the processes illustrated in FIGS. 1 through 3.

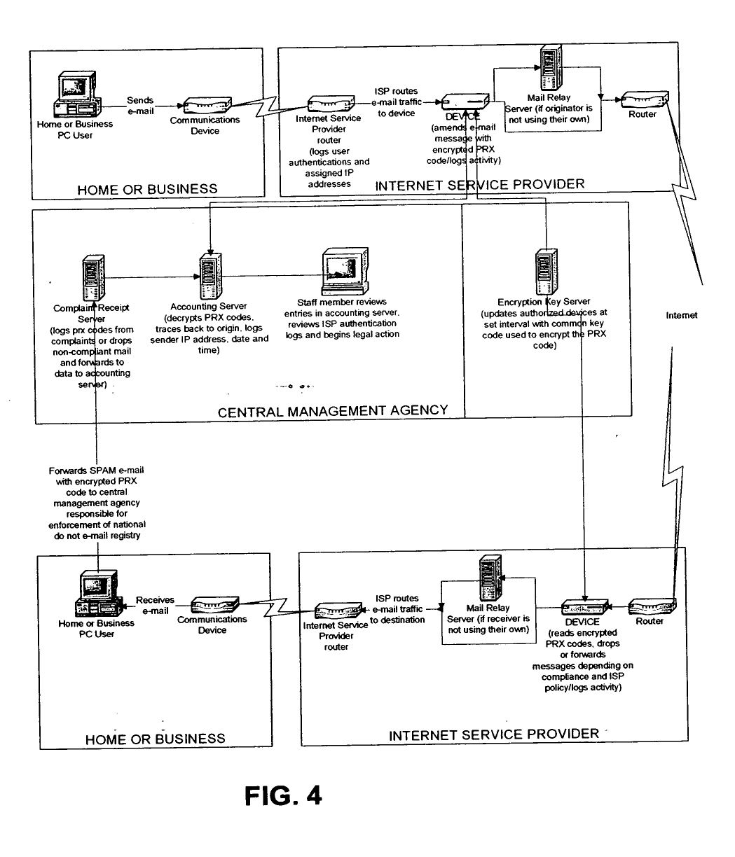

### DETAILED DESCRIPTION OF THE PREFERRED EMBODIMENT

In describing a preferred embodiment of the invention, specific terminology will be selected for the sake of clarity. However, the invention is not intended to be limited to the specific terms so selected.

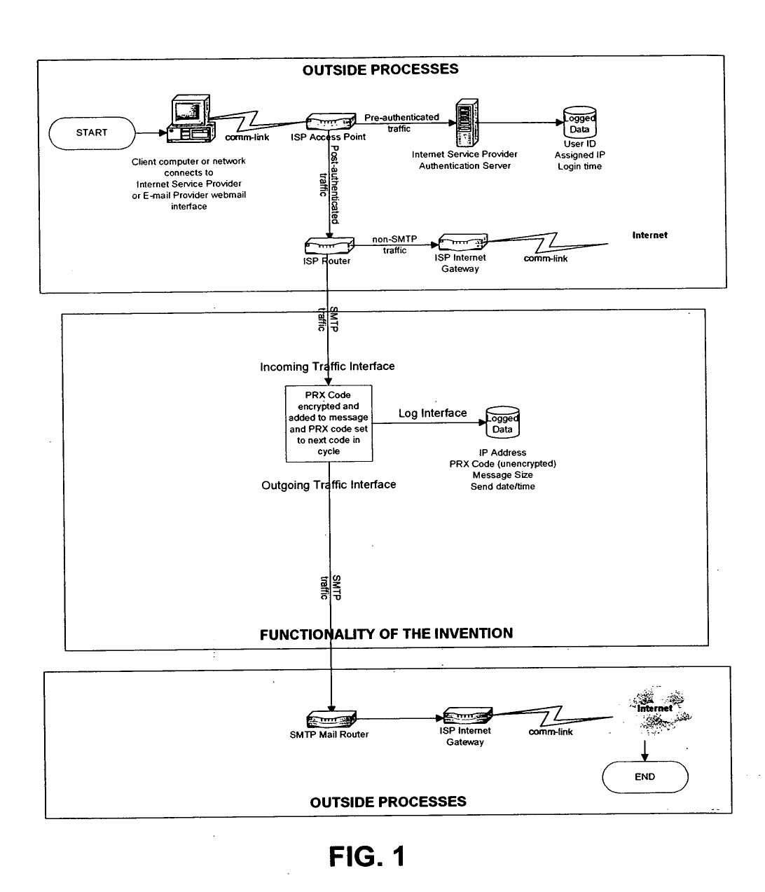

The invention is a system designed to be integrated into a networking appliance that will operate within computer networking environments operated by Internet Service Providers (ISPs). The invention could also be adapted to work in a software program. Referring now to FIG. 1, as block diagram of a preferred embodiment of the present invention is illustrated. As shown, the subject invention is implemented by an Internet Service Provider (ISP). However, an important aspect is the appliance that is issued by (or at least registered with) a governmental agency.

The invention will allow for all e-mail messages sent by a user to be amended with a special code when the message has reached the Internet Service Provider (ISP). This code will correlate to Internet Service Provider's (ISP's) customer login/connection records, thereby allowing authorized persons to trace an e-mail message back to the originator as reflected in an Internet Service Provider's actual login records. The problem of manipulation of message headers in order to disguise the sender of an e-mail will be solved as e-mail originators will not be able to alter the special code added by the Internet Service Provider.

Additionally, at the discretion of the Internet Service Providers, the physical form of the invention (referred to hereafter as the “device”), will be capable of validating all incoming e-mail messages so as to ensure incoming e-mails did legitimately originate from an authorized Internet Service Provider using a legitimate device.

Finally, at the discretion of the Internet Service Providers, the device will be able to discard* e-mail messages sent from a source not using a legitimate device so as to avoid the delivery of Internet e-mail messages that cannot be properly traced back to their originators. When a received message is discarded, the device will, at the discretion of the Internet Service Providers, send an error message to the apparent sender of the discarded message.

The invention can be integrated into a network appliance that integrates with the Internet Service Provider mail routing systems.

If a network appliance device is not desirable, the invention can be integrated into software daemons (services) that integrate directly into SMTP mail routing systems. Such an implementation would involve creating a core software program that interfaces into a secondary software program designed to interoperate with the SMTP mail routing system being used.

While the original intent of the device is to assist with the tracking of SMTP mail messages is another embodiment, the device could be adapted to handle any other type of TCP/IP packet based on the port of that packet. This will allow for the tracking of logging of any number of services including, but not limited to, peer to peer file sharing, streaming video and file transfers.

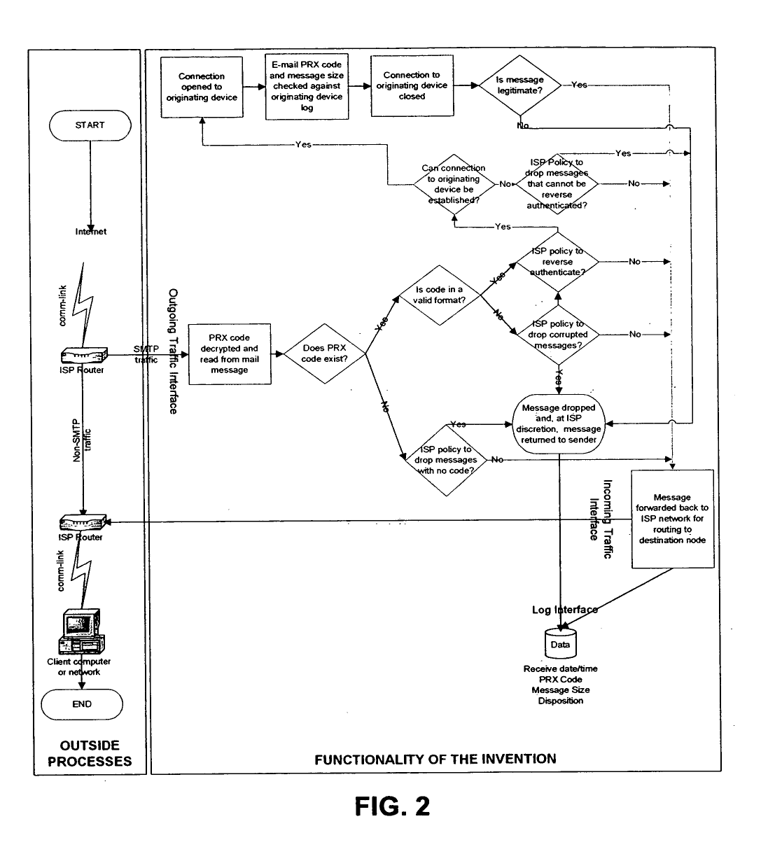

Referring now to FIG. 2, a block diagram of the e-mail signature code generation is shown. So as to ensure that only registered, authentic devices are used to provide e-mail tracking functionality, a central management agency will maintain records of all authenticated devices used by ISPs. The record will contain the device authentication code, assigned IP address given to it by the ISP and name of the ISP. As ISPs change their configurations, they will be required to update the central management agency.

The PRX codes attached to and read from e-mail messages will be encrypted using an encryption key held by the central management agency. This key will change on a regular interval. All devices will be configured to obtain this new key at the specified time from a network of key management systems employed by the central management agency. Devices registered with the central management agency will be able to obtain the new encryption keys. Devices not registered with the central management agency or deemed by the central management agency to be owned by ‘hostile’ ISPs (e.g. ISPs that opt not to retain authentication logs or offer anonymous mailing systems) will not receive new encryption keys.

During time periods when the encryption keys are being updated, outgoing mail messages will be queued at the device until the new encryption key is available so as to encrypt the PRX code. Incoming mail messages will continue to be processed utilizing the old code for a time interval that can be set, so as to allow for messages to be received while the new code is still being propagated to other devices.

In time, this will allow the central management agency and legitimate ISPs to determine who may or may not send e-mail messages to Internet users.

When the device is properly employed by Internet Service Providers, the following should result:

Any mail traffic that is sent that passes through the device should be marked and logged as shown herein.

The technique used to mark the traffic will be consistent regardless of what software, hardware or connections the ISP is using.

Any traffic that is marked can be traced back to the originating ISP.

The code assigned to the mark traffic will correspond to a log entry made by the device, which in turn will correspond to an authentication log entry maintained by the ISP.

ISPs will be able to set policies on devices and use a centralized management tool to set policies on all devices in their network.

Details of the ISPs customer records will remain largely private but can be reviewed by the government.

The central management agency (the government through its assigned agent(s) or outsourced entities), will have the ability to centrally manage the devices, including but not limited to: the registration of devices, managing the frequency of encryption key updates and reviewing device and e-mail activity in real-time.

The central management agency will be able to disable an ISP's ability to use a device if the ISP helps perpetuate undesired activity.

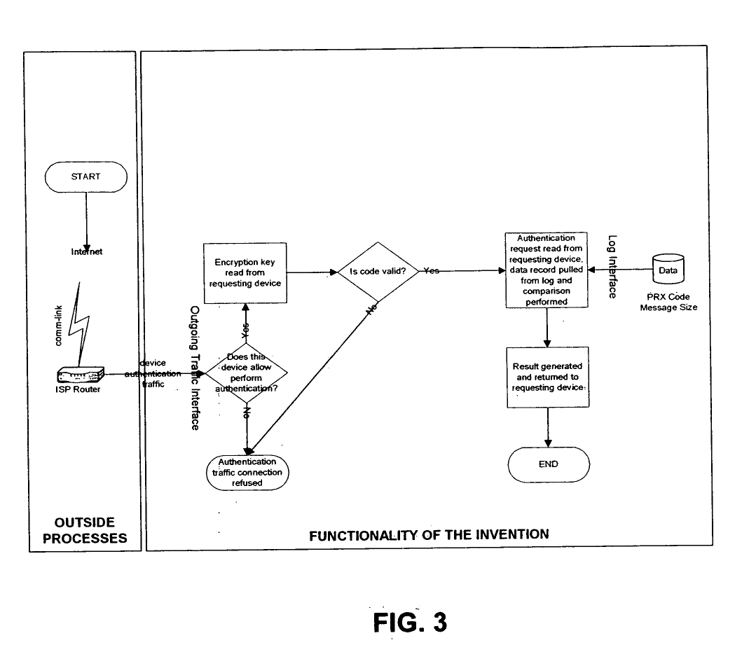

Referring now to FIG. 3, a block diagram of the appliance handling incoming e-mail is illustrated. The incoming traffic interface connects to the Internet Service Provider's network. The ISP forwards SMTP e-mail through the device prior to routing it to other Internet destinations.

The device attaches a signature code to each e-mail message it receives through the incoming traffic interface.

The first part of the signature is a device authentication code. This code allows for the mail message to be tracked back to its source ISP. The device authentication code is a five character alpha numeric fixed code permanently assigned to the device. Device authentication codes are registered with a central management agency along with the name of the ISP that owns the device and the public ISP address assigned to the device by the ISP. This factors in later as shown in Attachment A.

The second part of the signature is a five-character alphanumeric code ranging from 00000 (zeroes) through ZZZZZ and is stored in a counter in the device. After a code is attached to an e-mail message or packet, the counter is increased by one. The cycle repeats itself for each additional e-mail message or packet received by the device. When the device exhausts all of the signature codes, the cycle begins again with code 00000.

Example of cycle: 00000, 00001, 00002 . . . 00009, 0000A, 0000B, 0000C . . . 0000Z, 00010, 00011, 00012 . . . 00019, 0001A, 0001B, 0001C . . . 0001Z, 00020, 00021, 00022 . . .

The signature code is hereafter referred to as the PRX code. The PRX code is encrypted and added as a specific pre-defined header to each message. If for some reason a PRX code already exists in an email message, the new PRX code is amended to the pre-defined header in the e-mail message (the codes are separated with colons). Therefore, while receivers of e-mail Internet messages will be able to forward a SPAM e-mail message to a government agency responsible for the enforcement of a “National Do Not E-Mail Registry,” they will not be able to effectively read or manipulate the PRX code themselves. Details on the encryption methodology are attached in attachment A.

Referring again to FIG. 3, the outgoing traffic interface is illustrated. After the PRX code is attached as described above, the e-mail message or packet is routed to through the outgoing traffic interface to the Internet Service Provider's network. Depending on the ISP's configuration, this may be before a particular mail relay or TCP/IP router.

Traffic that cannot be passed through the Outgoing Network Interface is queued in the device until it can be sent. If the queue becomes full, traffic will not be accepted by the Incoming Network Interface.

The device logs the date and time of the message or packet (using the Julian date and GMT time zone), message or packet size, source IP address of the message or packet, and assigned PRX code. The logging interface can be configured to physically connect either to a database server or to a physical external storage device that may be optionally procured with the device. This physical external storage device will be configured to exclusively connect to the device. Depending on the option chosen by the ISP, that is where the activity is logged.

The activity log may be accessed via a secure connection made through the ISPs management software or by the central management agency. The activity log may also be referenced by another device performing reverse authentication seeking to validate whether a message is legitimate.

Through the graphical or other user interface where the device options can be configured, the ISP can set the duration for saving log entries. A minimum duration for the life of a log entry can be set.

SMTP traffic enters the ISP's network from the Internet and is routed to the device's Outgoing Traffic Interface. Once the traffic enters the device, the device decrypts and reads the PRX code.

If there is no PRX code, the ISP has the option of dropping* the traffic (so as to not receive any traffic from ISPs that do not utilize the system), or allowing the traffic to move through the network. If the traffic is dropped, a log entry is made and a message can be returned to the sender at the ISP's option. If the traffic is allowed to proceed through the network without a PRX code, a receipt log entry is made and it gets routed on through the ISP's network to be routed to the destination node.

If there is a PRX code, the traffic moves onto the next stage of authentication. For a higher degree of security, the ISP can reverse authenticate the traffic so as to ensure the originating device actually did send the traffic. This process allows the device to open a secure connection to the originating device so as to compare the traffic in question to the originating device's log entry. If the ISP opts for reverse authentication and a connection cannot be opened to the originating device due to network congestion, an inability of the receiving device to connect to the originating device, or because the ISP of the originating device has configured the device not to authenticate traffic, the ISP of the receiving device may opt to have the traffic dropped*. If the traffic is dropped, a log entry is made and a message can be returned to the originating device at the ISP's option. If the traffic is allowed to proceed forward even though the reverse authentication connection was unsuccessful, or if the ISP opts not to reverse authenticate the traffic, a receipt log entry is made and the mail message gets routed on through the ISP's network to be routed to the destination node.

If the reverse authentication connection can be made, the device checks the traffic's PRX code and message size against the originating device's log. If the traffic matches the log entry, a receipt log entry is made and the mail message gets routed on through the ISP's network to be routed to the destination node. If the traffic does not match a log entry, the traffic is dropped*, a log entry is made and a message can be returned to the originating device at the ISP's option.

Clearly, traffic processing will be more time consuming when higher degrees of security are chosen, however, with higher security the ISP will be better able to ensure only traffic that can be traced back to a legitimate source is the only traffic routed through its network.

Through a graphical or other user interface where device options can be configured, the ISP can set its policy for the handling and authenticating of incoming traffic, as well determine how it responds to requests for reverse authentication from other devices.

*Instead of dropping the e-mail message, the ISP may opt to prepend the message subject with “[UNTRACKABLE]” or some other text so as to alert the message recipient that the mail message could not be tracked. This could help third-party filtering systems route mail.

Any traffic approved to move on from the device through the ISP's network to the destination node passes through the Incoming Traffic Interface, usually to a router.

Traffic that cannot be passed through the Incoming Network Interface is queued in the device until it can be sent. If the queue becomes full, traffic will be dropped and error messages will be returned back to the originator.

The device logs the date and time of the message or packet received (using the Julian date and GMT time zone), the message or packet size, the PRX code and how the message or packet was disposed of (forwarded or dropped & why dropped).

Through a graphical or other user interface where device options can be configured, the ISP can set the duration for saving log entries. A minimum duration for the life of a log entry can be set.

The device will respond to management requests from two sources.

The ISP, utilizing software that will allow one or more devices to be managed simultaneously, will be able to modify settings and review logs of devices that it operates. The software will reference the device(s) by IP addresses and authorized ISP employees will be able to authenticate to the device using a username and password.

The central management agency, utilizing a master console system, will be able to access the logs and review the current activity of any legitimate device. The master console system will authenticate to the device using the encryption key.

Although this invention has been described and illustrated by reference to specific embodiments, it will be apparent to those skilled in the art that various changes and modifications may be made which clearly fall within the scope of this invention. The present invention is intended to be protected broadly within the spirit and scope of the appended claims.

1. A method of tracking electronic mail (e-mail) transmitted by a sender, the method comprising the steps of:
a) requiring each Internet Service Provider (ISP) to utilize an appliance, said appliance being registered with (if not issued by) a governmental agency or its representative, and each appliance having its own serial number;
b) amending each e-mail transmitted by a sender with an encrypted code containing an identification code unique (for a certain period of time) to each email sent through an Internet Service Provider and the serial number of said appliance, thereby allowing each e-mail to be traced back to the originating ISP.

2. The method of tracking electronic mail (e-mail) according to claim 1 wherein each identification code can be used to cross-reference an ISP's customer login and customer connection records for allowing each e-mail to be traced back to the sender.

3. The method of tracking electronic mail (e-mail) according to claim 1, after the step of amending the e-mail and after the e-mail has been transmitted by the sending ISP, further comprising the step of validating all incoming e-mails by the receiving ISP to ensure that e-mails originate from a registered appliance.

4. The method of filtering or labeling electronic mail (e-mail) according to claim 3 further comprising the step of optionally discarding or labeling e-mails that do not originate from a registered appliance.

5. The method of tracking electronic mail (e-mail) according to claim 1 wherein said appliance is rendered in hardware.

6. The method of tracking electronic mail (e-mail) according to claim 1 wherein said appliance is rendered in software.

7. The method of tracking electronic mail (e-mail) according to claim 1 wherein the method is adapted to track SMTP mail messages.

8. The method of tracking electronic mail (e-mail) according to claim 1 wherein the method is adapted to track TCP/IP packets.

9. The method of tracking electronic mail (e-mail) according to claim 1 further comprising the step of assisting the government in enforcing a National Do Not E-Mail Registry.

10. An apparatus for tracking electronic mail (e-mail) transmitted by a sender, the apparatus comprising:
a) an appliance registered with a governmental agency and issued to each Internet Service Provider (ISP), said appliance being assigned a unique serial number;
b) means of integrating said appliance into an ISP's SMTP e-mail routing system in order to amend each e-mail transmitted by a sender with an identification code and the serial number of said appliance, thereby allowing each e-mail to be traced back to the originating ISP.

11. The apparatus of claim 10 wherein each identification code can be used to cross-reference an ISP's customer login and customer connection records for allowing each e-mail to be traced back to the sender.
